(19) United States
(12) Patent Application Publication
(10) Pub. No.: US 2011/0100567 A1
(43) Pub. Date: May 5, 2011

(54) Loading Space Separation with an Extension Limiting Device

(75) Inventor: Sven Asendorf, Herrsching (DE)

(73) Assignee: HS Genion GmbH, Gilching (DE)

(21) Appl. No.: 12/882,093

(22) Filed: Sep. 14, 2010

(30) Foreign Application Priority Data
Oct. 29, 2009 (DE) DE 102009051283.7

(51) Int. Cl. E06B 9/88; E06B 9/80

(52) U.S. Cl. 160/293.1

(57) ABSTRACT

A safety device for a loading space of a motor vehicle comprises a housing in which a winding shaft is rotatably mounted and which has an outlet slot for a separating roller blind that can be wound up onto the winding shaft or can be unwound from the winding shaft and which is connected at an edge running transversely with respect to the winding direction to the winding shaft and at another edge thereof running transversely with respect to the winding direction to an extension bow that can be fixed in a roof lining region of the motor vehicle in question, and also an extension limiting device for the separating roller blind. The extension limiting device comprises a gap width reducing device for the outlet slot, which gap width reducing device can be switched between a release position, in which the separating roller blind can be completely unwound from the winding shaft, and a blocking position, in which the separating roller blind can be only partially unwound from the winding shaft.

### BACKGROUND OF THE INVENTION

1. Field of the Invention

The invention relates generally to a safety device for a loading space of a motor vehicle comprising a housing in which a winding shaft is rotatably mounted and which has an outlet slot for a separating roller blind that can be wound up onto the winding shaft or can be unwound from the winding shaft.

2. Related Technology

A safety device of this type is known in practice and is used to separate a vehicle passenger compartment from a loading space of the motor vehicle. By the separation that takes place by the separating roller blind of the safety device, objects being transported in the loading space are intended to be prevented from being hurled into the vehicle passenger compartment. The separating roller blind restrains the objects within the loading space.

A known safety device comprises a housing in which a winding shaft is rotatably mounted and which has an outlet slot for the separating roller blind that can be wound up onto the winding shaft or can be unwound from the winding shaft. The separating roller blind is typically of net-like design and runs through the outlet slot of the housing, which outlet slot extends parallel to the longitudinal axis of the winding shaft. To keep the separating roller blind, which can be fixed in the roof lining region of the motor vehicle in question via a tension bow or tension bar, under tension, the winding shaft is pre-stressed in a winding-up direction by a winding spring. When the tension bow is released from the fasteners arranged in the roof lining region, the separating roller blind therefore automatically winds up onto the winding shaft.

The above-described safety device is typically arranged behind an upper edge region of a backrest of a rear bench of the motor vehicle in question. For this purpose, lateral receptacles for the end regions of the housing in the safety device, into which receptacles said housing can be latched, can be arranged in the loading space.

In particular in the case of “station wagons,” it is possible, by turning over the rear bench or the backrest thereof, to enlarge the loading space, as a result of which the latter reaches virtually as far as the front seats of the motor vehicle in question. In order, in this case, to protect the vehicle occupants on the front seats from objects possibly flying around from the loading space, the safety device is moved into the front floor region (with respect to the vehicle orientation) of the loading space or into the rear region of the turned-over rear seat back. From there, the separating roller blind can then be extended upwardly in the vertical direction as far as the vehicle internal roof lining and fixed in the extension position. For this purpose, additional fixing devices for the tension bar of the separating roller blind are arranged on the vehicle interior roof lining. The extension length of the separating roller blind is greater when the rear bench is turned over than when the rear bench backrest is arranged upright. Therefore, in the case of the arrangement in which the safety device is arranged behind the upper edge region of the backrest arranged upright, a sufficient separating roller blind supply, which can be additionally unwound from the winding shaft when the rear bench is turned over, has to be maintained in the housing.

It has turned out, in the form of a problem relevant to safety, that objects hurled against the separating roller blind from the loading space could injure vehicle occupants if the separating roller blind supply is unwound from the winding shaft due to the resulting application of force and the formation of a bulge pointing toward the front of the vehicle. In order to counter this, it has been proposed for the edge of the outlet slot of the housing to have a serrated rail on which the net-like separating roller blind can be hooked and which thereby prevents an inadvertent unwinding of the separating roller blind from the winding shaft. However, this measure is effective only if the separating roller blind is formed from a wide-meshed net.

### SUMMARY OF THE INVENTION

The invention provides a safety device of the type described above, but having a reliable extension limit for the separating roller blind irrespective of the material composition of same.

Accordingly, the invention provides a safety device for a loading space of a motor vehicle, comprising a housing in which a winding shaft is rotatably mounted and which has an outlet slot for a separating roller blind that can be wound up onto the winding shaft or can be unwound from the winding shaft and that is connected at an edge running transversely with respect to a winding direction to the winding shaft and at another edge thereof running transversely with respect to the winding direction to an extension bow that can be fixed in a roof lining region of the motor vehicle in question, and an extension limiting device for the separating the roller blind.

According to the invention, the extension limiting device comprises a gap width reducing device for the outlet slot, which gap width reducing device can be switched between a release position, in which the separating roller blind can be completely unwound from the winding shaft, and a blocking position, in which the separating roller blind can be only partially unwound from the winding shaft.

According to the invention, the maximum extension length of the separating roller blind can consequently be set by the gap width of the outlet slot. In particular, when the rear bench backrest of the motor vehicle in question is arranged in an upright position, the gap width reducing device can therefore be switched into the blocking position thereof, in which, after a certain extension length, the separating roller blind is prevented by the reduced gap width of the outlet slot from being unwound further from the winding shaft. In a turned-over state of the rear bench backrest or of the rear bench, i.e. when a loading space in which the safety device can be arranged close to the front seats of the motor vehicle in question is enlarged, the gap width reducing device is expediently switched into the release position thereof, in which the separating roller blind can be completely unwound from the winding shaft and is therefore guided from the floor region of the loading space as far as the interior roof lining of the vehicle where it can be fixed via the extension bow or bar.

In a preferred embodiment, the gap width reducing device comprises an eccentric element that can be pivoted between the release position and the blocking position. The gap width of the outlet slot, which is formed on the housing, for the separating roller blind is therefore fixed by means of the rotational position of the eccentric element.

In another preferred embodiment, the separating roller blind has a thickened portion that runs transversely with respect to the extension direction and interacts with the gap width reducing device in the blocking position thereof. When the separating roller blind is extended in the blocking position of the gap width reducing device, the thickened portion of the separating roller blind therefore runs onto the gap width reducing device, thus blocking further extension of the separating roller blind.

In yet another preferred embodiment, the thickened portion of the separating roller blind is formed, for example, by a profile element inserted into the separating roller blind. For example, the profile element may be a plastic rod or a metal rod with a round or oval cross section, which rod is embedded, preferably sewn, into the material of the separating roller blind. As an alternative or in addition, it is possible to form the thickened portion by a stitched fold in the separating roller blind. It is also conceivable to manage entirely without the thickened portion. In this case, above a certain extension length, the friction between the separating roller blind and the eccentric element switched into the blocking position would then have to be of such a size that further extension of the separating roller blind is no longer possible.

To be able to switch the gap width reducing device as a function of the installed position of the safety device, an activating element preferably is provided, upon the actuation of which the gap width reducing device switches into the blocking position.

In a special embodiment of the invention, the activating element is a slide that has a toothing section that is in engagement with a toothing of the gap width reducing device. Upon actuation of the slide, the gap width reducing device, which is preferably an eccentric element, is therefore rotated and therefore pivoted out of the release position into the blocking position.

The slide can be pre-stressed into the deactivating position thereof by a spring. It is therefore possible, by contact against a surface of the vehicle-mounted bearing for the housing of the safety device, for the slide to be inevitably pressed in order to activate the gap reducing device, as a result of which the gap width reducing device switches into the blocking position, and, when the safety device is removed from the bearing, to be automatically pivoted back into the release position.

For the unambiguous fixing of the release position and of the blocking position, the gap width reducing device preferably has a stop element that interacts with at least one counter-stop of the housing to fix the release position and/or the blocking position.

In another special embodiment of the safety device, the eccentric element is mounted on a connecting tube that synchronizes locking devices arranged on both sides with respect to a longitudinal center plane of the vehicle.

In another special embodiment of the invention, the gap width reducing device comprises, as a switching element, an inertial element which, upon deceleration of the motor vehicle, switches the gap width reducing device into the blocking position. The inertial element preferably is a weight that is arranged eccentrically in relation to the axis of the gap width reducing device and is connected to the eccentric element or the gap width reducing device and switches, for example, from a deceleration of 10 g.

Further advantages and advantageous refinements of the invention may be understood from the following description, including the drawings and patent claims.

### BRIEF DESCRIPTION OF THE DRAWINGS

An exemplary embodiment of a safety device of the invention is illustrated in schematically simplified form in the drawings and is explained in more detail in the description below. In the drawings:

FIG. 1 shows a greatly schematized side view of a rear region of a motor vehicle when the rear bench backrest is arranged in an upright position;

FIG. 2 shows a view corresponding to FIG. 1, but when the rear bench backrest is turned over;

FIG. 3 shows a section through a safety device with a separating net when the extension limiting device is activated;

FIG. 4 shows a view corresponding to FIG. 3, but with the extension limiting device deactivated; and

FIG. 5 shows a section through the safety device in the region of an activating slide for activating and deactivating the extension limiting device.

### DETAILED DESCRIPTION

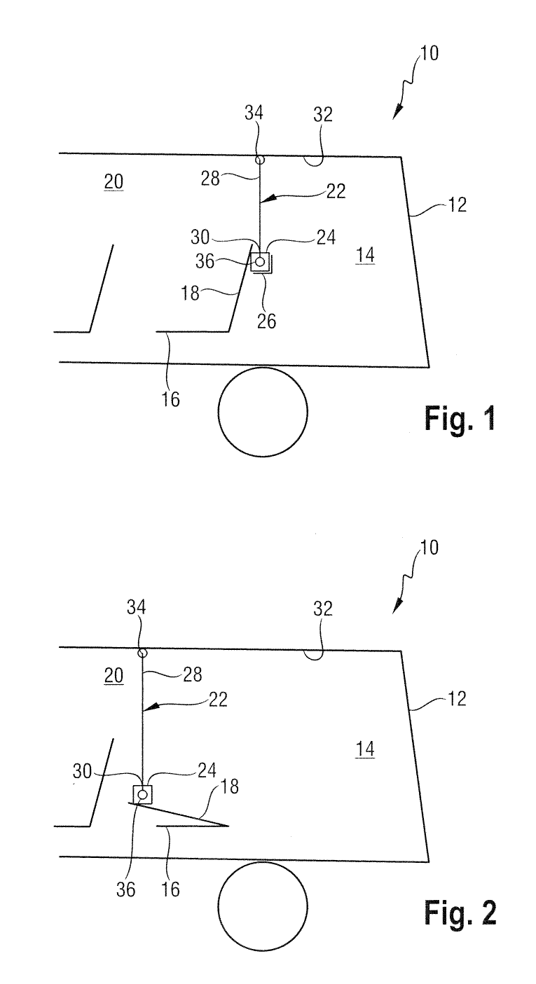

FIGS. 1 and 2 illustrate a motor vehicle 10, which is in the form of a “station wagon” and has a loading space 14 bounded on a rear side by a loading flap 12. The motor vehicle 10 is furthermore equipped with a rear bench 16 that has a backrest 18 which can be turned over. The backrest 18 can be pivoted between the upright position, which is illustrated in FIG. 1 and in which it bounds the loading space 14 on the front side, and a folded-over position, illustrated in FIG. 2 and in which the loading space 14 is expanded to the front and in which the rear side of the backrest 18 forms a loading space floor section in a front region of the loading space 14.

To separate the loading space 14 from a vehicle passenger compartment 20, the motor vehicle 10 is furthermore equipped with a safety device 22 by which occupants of the vehicle passenger compartment 20 can be protected from objects that may be hurled forwardly in accident situations or the like. The safety device 22 is assigned a first installed situation, which is illustrated in FIG. 1, and a second installed situation, which is illustrated in FIG. 2. In the first installed situation, the safety device 22 together with a housing 24 is mounted in lateral, body-mounted receptacles 26 adjacent to the rear side of the backrest 18 of the rear bench 16. In the second installed situation, which is illustrated in FIG. 2, the housing 24 of the safety device 22 is pivoted forwardly and downwardly together with the backrest 18. In both installed situations, a separating net 28 leads at least approximately vertically upwardly through an outlet slot 30 of the housing 24 as far as an interior roof lining 32 of the vehicle interior where it is fixed via an extension bow or bar 34. The extension length of the separating net 28, which constitutes a catch net, is greater in the installed position illustrated in FIG. 2 than in the first installed situation which is illustrated in FIG. 1 and in which a separating net supply is retained on a winding shaft 36 arranged in the housing 24 and on which the separating net 28 can be wound up or from which the separating net 28 can be unwound and which is pre-stressed in the winding-up direction of the separating net 28 by means of a spring (not illustrated specifically).

The separating net 28 is sewn in an end region running in the transverse direction of the vehicle to form a loop through which the winding shaft 36 passes and which is connected to the winding shaft 36 by means of rivets (not illustrated) to safeguard against rotation.

Furthermore, at the end regions of the separating net 28, which are arranged in the region of the receptacle 26, the safety device 22 is in each case equipped with a holding system that permits captive connection to the receptacles 26.

To be able to limit the extension length of the separating net 28, in the housing 24 of the safety device an eccentric element 38 extending in the transverse direction of the vehicle is mounted rotatably on a connecting tube 40 that connects the holding systems, which are formed on both sides of the safety device 22 and are intended for connection to the vehicle-mounted receptacles 26, to each other and thereby ensures the synchronous actuation thereof.

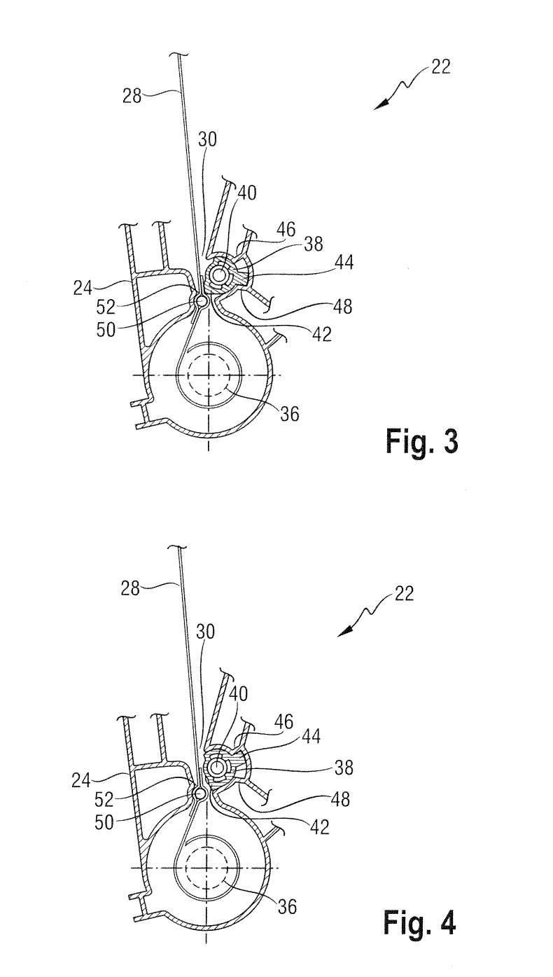

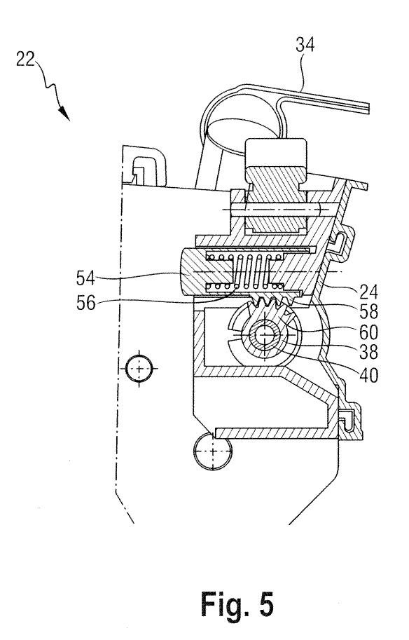

The eccentric element 38 that forms the gap width reducing device and which is of tubular design has an eccentric cam 42 by which, in an appropriate rotational position of the eccentric element 38 in relation to the housing 24, the gap width of the outlet slot 30 can be reduced in the manner illustrated in FIG. 3. To reduce the gap width of the outlet slot 30, the eccentric cam 42 of the eccentric element 38 is therefore rotated into the outlet slot 30, and therefore protrudes into the outlet slot 30. This corresponds to the locking position of the eccentric element 38 or of the extension limiting device formed by the latter. In the release position, the eccentric cam 42 of the eccentric element 38 is pivoted in such a manner that the outlet slot 30 of the housing 24 is substantially fully released.

For the unambiguous fixing of the release position and of the blocking position of the eccentric element 38, the latter is provided with a stop element 44 that interacts with counter-stops 46 and 48 of the housing 24.

To be able to interact with the eccentric element 38, the separating net 28 has a thickened portion 52 formed by a plastic bar 50 and, in the blocking position of the eccentric element 38, moves, when the separating net 28 is extended, onto the eccentric cam 42, as illustrated in FIG. 3. When the eccentric element 38 is pivoted into the release position thereof (cf. FIG. 4), the thickened portion 52 can be pulled through the outlet slot 30 past the eccentric element 38, and therefore the separating net 28 can be unwound completely from the winding shaft 36.

The respective switching position, in which the separating net 28 can be unwound from the winding shaft 36 only partially (first installed situation) or completely (second installed situation), is determined by an activating slide 54 that is pre-stressed into a deactivating position by a spring 56 and the axis of which in a vertical projection is oriented at right angles with respect to the axis of the eccentric element 38 or of the winding shaft 36. The activating slide 54 has a toothing section 58 in engagement with a toothing 60 formed in an end region of the eccentric element 38, which is of tubular design. In a relaxed state of the spring 56, i.e. in the extended state of the activating slide 54, the eccentric element 38 takes up the release position thereof, which is illustrated in FIG. 4. If the activating slide 54 is pressed, which is the case in the first installed situation or with the safety device on the top side of the rear bench 16 by the end surface of the activating slide 54 bearing against a vehicle-mounted counter-surface, the eccentric element 38 is rotated into the blocking position thereof, which is illustrated in FIG. 3, such that said eccentric element acts as a gap width reducing device for the outlet slot 30 and, in conjunction with the thickened portion 52 of the separating net 28, limits the maximum extension length of the separating net 28. When not mounted on the vehicle-mounted receptacles 26, the activating slide 54 is therefore pressed outwardly by the spring 56 with respect to the housing 24 against a stop of same. As a result, the eccentric element 38 is kept in the release position thereof, in which the eccentric cam 42 substantially completely releases the outlet slot 30. The extension limiting device, which is formed by the eccentric element 38, is therefore taken out of operation, as a result of which the separating net 28 can be completely extended. This is also required in the second installed situation which is illustrated in FIG. 2 and in which the separating net is intended to be pulled from the loading space floor as far as the interior roof lining of the vehicle interior.

When the safety device 22 is secured on the receptacles 24, i.e. in the first installed situation, the activating slide 54 is pressed, as a result of which the eccentric element 38 is rotated into the blocking position thereof, in which the eccentric cam 42 partially conceals the outlet slot 30. This blocking position is assigned to the first installed situation which is illustrated in FIG. 3 and in which the backrest 18 of the rear bench 16 is arranged in an upright position.

### LIST OF REFERENCE NUMBERS

10 Motor vehicle
12 Loading flap
14 Loading space
16 Rear bench
18 Backrest
20 Vehicle passenger compartment
22 Safety device
24 Housing
26 Receptacle
28 Separating net
30 Outlet slot
32 Interior roof lining
34 Extension bar
36 Winding shaft
38 Eccentric element
40 Connecting tube
42 Eccentric cam
44 Stop element
46 Counter-stop
48 Counter-stop
50 Plastic bar
52 Thickened portion
54 Activating slide
56 Spring
58 Toothing section
60 Toothing

1. A safety device for a loading space of a motor vehicle, comprising a housing in which a winding shaft is rotatably mounted and which has an outlet slot for a separating roller blind that can be wound up onto the winding shaft or can be unwound from the winding shaft and which is connected at an edge running transversely with respect to the winding direction to the winding shaft and at the other edge thereof running transversely with respect to the winding direction to an extension bow that can be fixed in a roof lining region of the motor vehicle in question, and also an extension limiting device for the separating roller blind, wherein the extension limiting device comprises a gap width reducing device for the outlet slot, which gap width reducing device can be switched between a release position, in which the separating roller blind can be completely unwound from the winding shaft, and a blocking position, in which the separating roller blind can be only partially unwound from the winding shaft.

2. The safety device of claim 1, wherein the gap width reducing device comprises an eccentric element that can be pivoted between the release position and the blocking position.

3. The safety device of claim 1, wherein the separating roller blind has a thickened portion that runs transversely with respect to the extension direction and interacts with the gap width reducing device in the blocking position thereof.

4. The safety device of claim 3, wherein the thickened portion is formed by a profile element embedded in the separating roller blind.

5. The safety device of claim 1, wherein the gap width reducing device is connected to an activating element, upon the activation of which in the activating position the gap width reducing device switches into the blocking position.

6. The safety device of claim 5, wherein the activating element is a slide having a toothing section in engagement with a toothing of the gap width reducing device.

7. The safety device of claim 6, wherein the slide is pre-stressed into the deactivating position thereof by a spring.

8. The safety device of claim 1, wherein the gap width reducing device has a stop element that interacts with at least one counter-stop of the housing to fix the release position and/or the blocking position.

9. The safety device of claim 2, wherein the eccentric element is mounted on a connecting tube that synchronizes locking devices arranged on both sides with respect to a longitudinal center plane of the vehicle to connect the housing to the vehicle body.

10. The safety device of claim 1, wherein the gap width reducing device comprises, as a switching element, an inertial element which, upon deceleration of the vehicle, switches the gap width reducing device into the blocking position.

11. The safety device of claim 10 wherein the inertial element is a weight arranged eccentrically with respect to the axis of the gap width reducing device.
